(19) United States
(12) Patent Application Publication
(10) Pub. No.: US 2024/0263686 A1
(43) Pub. Date: Aug. 8, 2024

(54) DRIVE UNIT

(71) Applicant: fischer automotive systems GmbH & Co. KG, Horb a.N (DE)

(72) Inventor: Ulf-Lothar Bastian, Pfalzgrafenweiler (DE)

(73) Assignee: fischer automotive systems GmbH & Co. KG, Horb a.N (DE)

(21) Appl. No.: 18/431,987

(22) Filed: Feb. 4, 2024

(30) Foreign Application Priority Data
Feb. 6, 2023 (DE) 10 2023 102 835.9

(51) Int. Cl. F16H 3/36

(52) U.S. Cl. CPC F16H 3/366

(57) ABSTRACT

A drive unit includes a wheel distribution gear mechanism for driving two output wheels as a function of the direction of rotation. An intermediate wheel, which meshes with a drive wheel of the wheel distribution gear mechanism, is movably guided on a circular path that is concentric with respect to an axis of rotation of the drive wheel, so as to reach a first driving position, meshing with a first output wheel, during rotation in a first direction of rotation, and a second driving position, meshing with a second output wheel, during rotation in an opposite second direction of rotation.

### CROSS-REFERENCE TO RELATED APPLICATIONS

This application claims priority under 35 USC § 119 to German Patent Application No. 10 2023 102 835.9, filed Feb. 6, 2023, the entire disclosure of which is incorporated herein by reference.

### TECHNICAL FIELD

The invention relates to a drive unit.

### DISCUSSION OF RELATED ART

The international patent application WO 2020/172098 A1 describes a drive unit comprising an electric motor and a gear wheel distribution gear mechanism, via which two outputs can be rotationally driven by way of the electric motor as a function of the direction of rotation. The gear wheel distribution gear mechanism comprises a drive wheel, which is rotationally fixed on a motor shaft of the electric motor, two output wheels spaced equidistantly apart from the motor shaft, which are offset from one another in a circumferential direction of the motor shaft, and two coaxial intermediate wheels that are rotationally fixed with respect to one another, of which a larger intermediate wheel always meshes with the drive wheel, and a smaller intermediate wheel selectively meshes with one of the two output wheels. The two intermediate wheels are rotatably mounted on a pivoting lever, which can be pivoted about the motor shaft of the electric motor, wherein a brake transmits torque from the motor shaft to the pivoting lever. As a result, the pivoting lever is pivoted in a direction of rotation of the motor shaft so that the smaller intermediate wheel meshes with one of the two output wheels. In the opposite direction of rotation, the pivoting lever pivots in an opposite direction until the smaller intermediate wheel meshes with the other output wheel. In this way, the one output wheel is driven when the motor shaft of the electric motor is rotated in the one direction of rotation, and the other output wheel is driven in the opposite direction of rotation when the motor shaft is rotated in the opposite direction of rotation.

### SUMMARY OF THE INVENTION

It is the object of the invention to provide a drive unit, in which a driving operation of at least one output wheel is dependent on the direction of rotation, without braking-torque on a drive.

The drive unit according to the invention comprises a wheel distribution gear mechanism comprising a drive wheel, a first intermediate wheel, and a first output wheel, which can be rotationally driven by way of the drive wheel via the first intermediate wheel. The drive unit does not have to comprise any further output wheels than the first output wheel, but can comprise one or more further output wheels. Likewise, it is possible for more than one intermediate wheel to be present, via which the output wheels can be rotationally driven by the drive wheel. While more than one drive wheel is not provided, this is also not precluded.

The drive unit comprises a first guide for the first intermediate wheel, which movably guides the first intermediate wheel on a circular path that is concentric with respect to an axis of rotation of the drive wheel. In the process, an axis of rotation of the first intermediate wheel, in particular, moves on the circular path, wherein the first intermediate wheel can additionally rotate about the axis of rotation thereof. The first intermediate wheel is in contact with the drive wheel at all points of the guide and is rotationally driven by the drive wheel during rotation of the drive wheel. The first guide for the first intermediate wheel is self-locking free so that torque transmitted by the drive wheel to the first intermediate wheel during rotational driving moves the first intermediate wheel along the guide. Driving in a first direction of rotation moves the first intermediate wheel along the first guide into a first driving position, in which the first intermediate wheel is in contact not only with the drive wheel, but also with the first output wheel, so that the drive wheel drives the first output wheel, via the first intermediate wheel, so as to rotate. Driving in the reverse direction of rotation brings the first intermediate wheel out of contact with the first output wheel so that the first output wheel is not driven via the first intermediate wheel.

“Self-locking free” shall be understood to mean that friction of the first intermediate wheel at or in the first guide is so low that the torque, which is transmitted by the drive wheel to the first intermediate wheel when the first intermediate wheel is rotationally driven, moves the first intermediate wheel in the direction of rotation of the drive wheel, along the first guide. During the rotation in the first direction of rotation, the torque transmitted by the drive wheel to the first intermediate wheel moves the first intermediate wheel along the first guide until the first intermediate wheel makes contact with the first output wheel, and rotationally drives the first output wheel. The position of the first intermediate wheel at or in the first guide, in which the first intermediate wheel is in contact with the first output wheel, is the first driving position.

No braking torque is exerted on the drive wheel or, generally speaking, a drive for moving the first intermediate wheel into the first driving position, and possibly into a second driving position.

The wheel distribution gear mechanism preferably comprises two output wheels, one of which can, in each case, be driven, as a function of the direction of rotation, by the drive wheel via the first intermediate wheel. In the process, the torque transmitted by the drive wheel to the first intermediate wheel during rotational driving moves the first intermediate wheel along the self-locking free first guide into one of two driving positions as a function of the direction of rotation. During rotational driving in the first direction of rotation, the torque moves the first intermediate wheel into the first driving position, and during reverse rotational driving in a second direction of rotation opposite the first direction of rotation, the torque moves the first intermediate wheel in an opposite direction along the first guide into a second driving position. In the first driving position, the first intermediate wheel is in contact with the first output wheel so that, during the rotation in the first direction of rotation, the drive wheel rotationally drives the first output wheel via the first intermediate wheel. In the second driving position, the first intermediate wheel is in contact with the second output wheel so that, during the rotation in the second direction of rotation, the drive wheel rotationally drives the second output wheel via the first intermediate wheel.

The guide of the first intermediate wheel is, in particular, a circular curve guide or has a circular curve guide, which movably guides the first intermediate wheel on the circular path that is concentric with respect to the axis of rotation of the drive wheel.

For the circular curve guidance of the first intermediate wheel, one embodiment of the invention provides a concave, circular, curved path that is concentric with respect to the axis of rotation of the drive wheel. The first intermediate wheel comprises an intermediate wheel shaft that is concentric with respect to the axis of rotation thereof and that rolls on the curved path so that the first intermediate wheel, during the rotation in the first direction of rotation, moves along the curved path into the first driving position and, during the rotation in the opposite second direction of rotation, moves into the second driving position. The movement of the first intermediate wheel is stopped by the first or the second output wheel when the first intermediate wheel, in the first or second driving position, is in contact with the first or the second output wheel. Upon further rotation, the intermediate wheel shaft glides on the curved path, wherein the torque exerted by the drive wheel on the first intermediate wheel keeps the first intermediate wheel in contact with the first or the second output wheel.

One embodiment of the invention provides two intermediate wheels, and a guide for each intermediate wheel. Both guides are self-locking free. A first guide guides the first intermediate wheel on the circular path concentric with respect to the axis of rotation of the drive wheel, and a second guide guides a second intermediate wheel on a circular path that is likewise concentric with respect to the axis of rotation of the drive wheel. During rotational driving in the first direction of rotation, the torque transmitted by the drive wheel to the first intermediate wheel moves the first intermediate wheel into the first driving position, and moves the second intermediate wheel out of a second driving position, which is to say, out of contact with the second output wheel. In the reverse direction of rotation, the torque transmitted by the drive wheel to the second intermediate wheel moves the second intermediate wheel into the second driving position, in which the second intermediate wheel is in contact with the second output wheel so that the second output wheel can be rotationally driven by way of the drive wheel via the second intermediate wheel. As a result of the rotation of the drive wheel, the first intermediate wheel is moved out of the first driving position, which is to say, out of contact with the first output wheel. During rotation in the first direction of rotation, the drive wheel thus drives the first output wheel via the first intermediate wheel, and during rotation in the second direction of rotation, the drive wheel rotationally drives the second output wheel via the second intermediate wheel. The second output wheel is not driven during the rotation in the first direction of rotation, and the first output wheel is not driven during the rotation in the second direction of rotation.

According to one embodiment of the invention, a second output wheel that is coaxial with the drive wheel is provided, which is driven in the second direction of rotation via a freewheel by the drive wheel. In the first direction of rotation, the freewheel decouples the second output wheel from the drive wheel so that the second output wheel is not driven in the first direction of rotation. In the first direction of rotation, the first intermediate wheel reaches the first driving position and rotationally drives the first output wheel.

In one embodiment of the invention, the freewheel has a circular curve that is concentric with respect to the axis of rotation of the drive wheel, which is also an axis of rotation of the coaxial second output wheel, and includes at least one branch, and preferably several branches, toward the inside or toward the outside, which are distributed evenly, or also unevenly, over a circumference. The branches extend obliquely with respect to imaginary radials, with all branches in the same circumferential direction being oblique. Preferably, all branches have the same slant, which is to say the same angle, with respect to the radials; however, these may also be oblique at different angles with respect to the radials. The circular curve including the branches is rigid with the drive wheel or with the second output wheel. The circular curve cooperates with a follower, which engages in the circular curve or engages thereon. The follower is movable obliquely with respect to a radial, in a circumferential direction opposite that of the branches of the circular curve, at the second output wheel or the drive wheel, thus movable from the circular curve to the ends of the branches. Rotation in the first direction of rotation urges the follower, when the same is situated in one of the branches, into the circular curve, whereby the second output wheel can be rotated in relation to the drive wheel. Rotation in the second direction of rotation urges the follower into one of the branches, whereby the second output wheel rotates along with the drive wheel.

The wheel distribution gear mechanism is preferably designed as a gear wheel distribution gear mechanism comprising gear wheels meshing with one another. However, a friction wheel distribution gear mechanism comprising friction wheel rolling on one another, or a combination of gear wheel distribution gear mechanism and friction wheel distribution gear mechanism, is also possible.

The features and feature combinations, designs, and embodiments of the invention mentioned above in the description, and the features and feature combinations mentioned hereafter in the description of the figures and/or shown in a figure, can be used not only in the respective indicated or illustrated combination, but also in other essentially arbitrary combinations, or alone. Embodiments of the invention that do not include all the features of a dependent claim are possible. It is also possible to replace individual features of a claim with other disclosed features or feature combinations. Embodiments of the invention that do not include all the features of the exemplary embodiment or exemplary embodiments, but an essentially arbitrary portion of the characterizing features of one exemplary embodiment, optionally in combination with one, more or all the features of one or more further exemplary embodiments, are possible.

### BRIEF DESCRIPTION OF THE DRAWING

The invention will be described hereafter in greater detail based on several exemplary embodiments shown in the drawings. In the drawings:

FIG. 1 shows a front view of a first exemplary embodiment of the invention;

FIG. 2A shows a side view of the first exemplary embodiment of the invention shown in FIG. 1;

FIG. 2B shows an enlarged illustration of a detail according to arrow Ila of FIG. 2A;

FIG. 3 shows a front view of a second exemplary embodiment of the invention;

FIG. 4A shows a front view of a third exemplary embodiment of the invention; and

FIG. 4B shows an individual part of the third exemplary embodiment.

### DETAILED DESCRIPTION OF THE INVENTION

The figures show simplified and schematic illustrations of the exemplary embodiments to provide an understanding of the invention and to describe the invention. In general, identical parts are denoted by the same reference numerals in the figures.

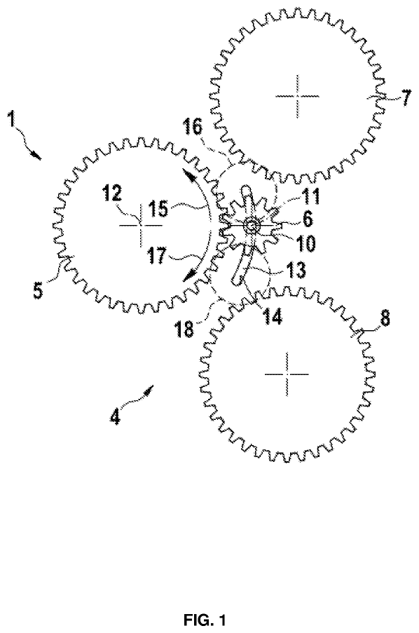

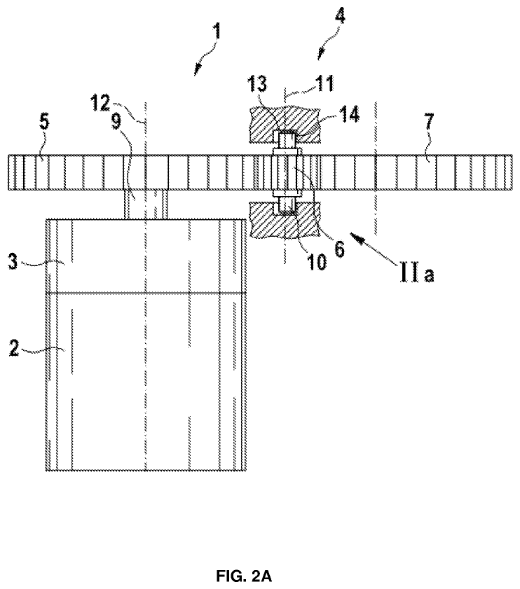

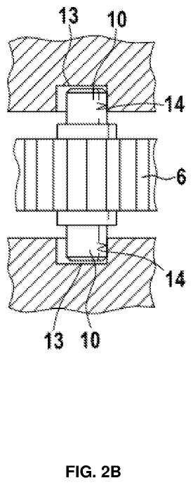

The drive unit 1 according to the invention shown in FIGS. 1 and 2A is provided for rotationally driving two outputs by way of a drive, in the exemplary embodiment by way of an electric motor 2, as a function of the direction of rotation. In the exemplary embodiment, the electric motor 2 is a gear motor comprising a flange-mounted gear mechanism 3. The invention is not limited to a driving operation by way of an electric motor 2.

The drive unit 1 comprises a wheel distribution gear mechanism 4 comprising a drive wheel 5, a first intermediate wheel 6, a first output wheel 7, and a second output wheel 8. The second output wheel 8 is not shown in FIG. 2A, since this would conceal the first intermediate wheel 6 and the first output wheel 7. Embodiments of the invention that include only one output wheel 7 (or 8) are also possible. In the exemplary embodiment, the wheel distribution gear mechanism 4 is a gear wheel distribution gear mechanism, and the drive wheel 5, the first intermediate wheel 6, and the output wheels 7, 8 are spur gear wheels having parallel axes of rotation, with other gear wheels also being possible (not shown). Embodiments of the invention that include a friction wheel distribution gear mechanism having friction wheels that roll on one another, or against one another with the circumferences thereof, serving as the wheel distribution gear mechanism 4 are also possible (not shown).

The drive wheel 5 is non-rotatably disposed on a motor shaft 9 of the electric motor 2 or on a gear shaft of the gear mechanism 3, which is likewise referred to as a motor shaft 9 here, to simplify matters.

The first intermediate wheel 6 meshes with the drive wheel 5. An intermediate wheel shaft 10 of the first intermediate wheel 6, which is concentric with respect to the first intermediate wheel 6 and coaxial with respect to an axis of rotation 11 of the first intermediate wheel 6, is guided, on both end faces of the first intermediate wheel 6, in grooves that run concentrically about an axis of rotation 12 of the drive wheel 5 in circular arcs that are congruent when viewed from the front. The two grooves form a first guide 13 for the first intermediate wheel 6, which movably guides the first intermediate wheel 6 on a circular arc that is concentric with respect to the axis of rotation 12 of the drive wheel 5. Since the first intermediate wheel 6 is guided on the circular arc that is concentric with respect to the axis of rotation 12 of the drive wheel 5, it always meshes with the drive wheel 5.

When the first intermediate wheel 6 is rotationally driven by way of the drive wheel 5, the first intermediate wheel 6 is acted upon by a force that is directed away from the axis of rotation 12 of the drive wheel 5, and torque is transmitted from the drive wheel 5 to the first intermediate wheel 6. The force directed away from the axis of rotation 12 of the drive wheel 5 causes the intermediate wheel shaft 10 to roll or glide on a concave, outer groove flank, facing the drive wheel 5, of the groove forming the guide 13 for the first intermediate wheel 6 (FIG. 2a). The groove flank on which the intermediate wheel shaft 10 rolls or glides forms a circular arc-shaped guide path 14 of the guide 13, which is concentric with respect to the axis of rotation 12 of the drive wheel 5, or forms a circular curve guide of the first intermediate wheel 6. The intermediate wheel shaft 10 is not guided by the guide 13 to move the intermediate wheel 6 toward the axis of rotation 12, and in particular is not guided by the groove flank facing away from the drive wheel 5, but rather is guided by the meshing engagement of the intermediate wheel 6 in the drive wheel 5. In this regard, a projection, instead of a groove, would also suffice as a guide 13 (not shown).

The torque exerted by the drive wheel 5, during rotational driving, on the first intermediate wheel 6 meshing therewith, and the intermediate wheel shaft 10 rolling at or in the guide 13 or on the guide path 14, move the first intermediate wheel 6, in the direction of rotation of the drive wheel 5, in or along the guide 13 of the first intermediate wheel 6. This means that the first intermediate wheel 6, when rotationally driven, moves on the circular path that is concentric with respect to the axis of rotation 12 of the drive wheel 5, in the direction of rotation of the drive wheel 5, until the first intermediate wheel 6 reaches one of the two output wheels 7, 8, and teeth of the output wheel 7, 8 enter into meshing engagement with the first intermediate wheel 6.

A position in which the first intermediate wheel 6 meshes with one of the two output wheels 7, 8 is referred to here as a driving position 16, 18 of the first intermediate wheel 6. In the case of a first direction of rotation 15 of the drive wheel 5, which is shown in FIG. 1 by way of a circular arrow, the first intermediate wheel 6 reaches a first driving position 16, in which this meshes with the drive wheel 5 and with the first output wheel 7. An opposite second direction of rotation 17 of the drive wheel 5 moves the first intermediate wheel 6 in or along the guide 13, in an opposite direction, into a second driving position 18, in which the first intermediate wheel 6 meshes with the drive wheel 5 and with the second output wheel 8.

The two driving positions 16, 18 of the intermediate wheel 6 are illustrated with dotted lines in FIG. 1.

The drive unit 1 according to the invention thus rotationally drives one of the two output wheels 7, 8, as a function of the direction of rotation 15, 17 of the drive wheel 5, via the first intermediate wheel 6.

The guide 13 of the first intermediate wheel 6 including the two grooves, on the outer groove flanks of which the intermediate wheel shaft 10 rolls or glides, is self-locking free. This means that friction at or in the guide 13 is so low that torque transmitted by the drive wheel 5 to the first intermediate wheel 6 during rotational driving is so minimal that the first intermediate wheel 6, during, and as a result of, the rotational driving, moves, as a function of the direction of rotation, into one of the two driving positions 16, 18, in which the first intermediate wheel 6 meshes with one of the two output wheels 7, 8, and rotationally drives the particular output wheel 7, 8. The guide 13 of the first intermediate wheel 6 on the circular arc concentric with respect to the axis of rotation 12 of the drive wheel 5 does not exert any braking torque on the motor shaft 9 of the electric motor 2, or the gear shaft of the gear mechanism 3, which is to say the guide 13 of the first intermediate wheel 6 does not decelerate the driving operation of the drive wheel 5 by way of the electric motor 2 and the gear mechanism 3.

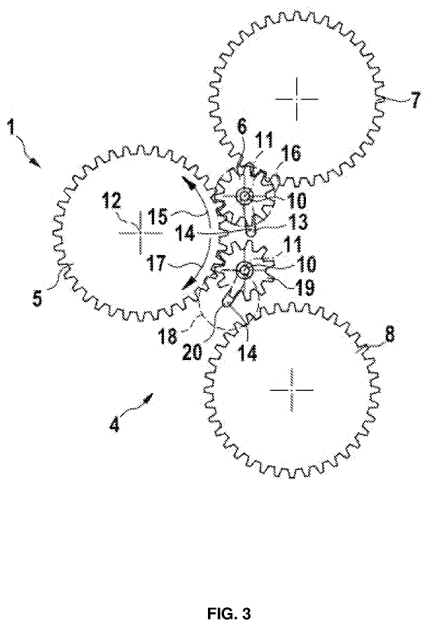

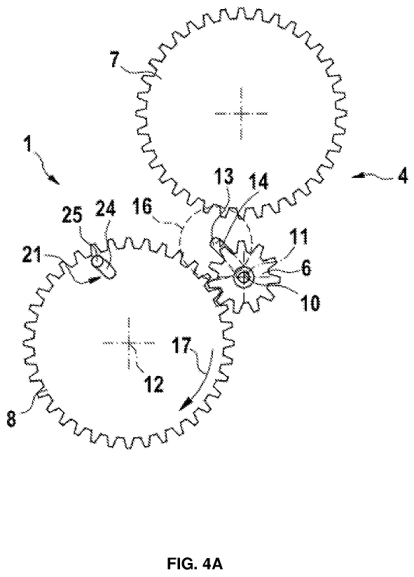

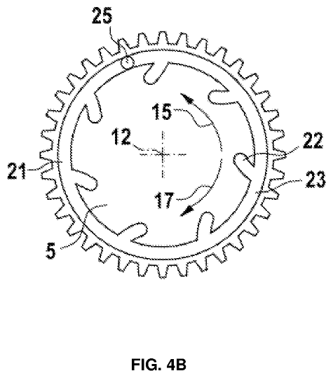

The descriptions of FIGS. 3 and 4A below essentially describe the differences compared to FIGS. 1 and 2A and reference is also made to the description of FIGS. 1 and 2A.

As in FIG. 1, the wheel distribution gear mechanism 4 of the drive unit 1 according to the invention shown in FIG. 3 comprises a drive wheel 5, two output wheels 7, 8, and two intermediate wheels 6, 19, instead of one, which are offset from one another in a circumferential direction of the drive wheel 5. As in FIG. 1, the intermediate wheel shafts 10 of the two intermediate wheels 6, 19 are guided in circular arc-shaped grooves that are concentric with respect to the axis of rotation 12 of the drive wheel 5 and serve as guides 13, 20, so that the two intermediate wheels 6 can be moved on circular arc-shaped paths that are concentric with respect to the axis of rotation 12 of the drive wheel 5, wherein both intermediate wheels 6, 19 always mesh with the drive wheel 5.

The two intermediate wheels 6, 19 can have differing diameters, and the guides 13, 20 thereof can have differing radii and radial distances with respect to the axis of rotation 12 of the drive wheel 5. In the exemplary embodiment, the two intermediate wheels 6, 19 have the same diameter, and the guides 13, 20 thereof have the same radius and radial distance with respect to the axis of rotation 12 of the drive wheel 5.

In a friction wheel distribution gear mechanism, serving as the wheel distribution gear mechanism 4, instead of the gear wheel distribution gear mechanism, the intermediate wheels 6, 19 would roll on the circumference of the drive wheel 5. The guide 13 of the first intermediate wheel 6 will also be referred to hereafter as the first guide 13, and the guide 20 of the second intermediate wheel 19 will also be referred to hereafter as the second guide 20.

Rotational driving of the two intermediate wheels 6, 19 by way of the drive wheel 5, the intermediate wheel shafts 10 of which roll on the outer groove flanks of the grooves that form the circular arc-shaped guide paths 14 for the intermediate wheel shafts 10 which are concentric with respect to the axis of rotation 12 of the drive wheel 5, moves the two intermediate wheels 6, 19 in the direction of rotation 15, 17 about the drive wheel 5. In the process, one of the two intermediate wheels 6, 19 reaches the driving position, in which this meshes with the assigned output wheel 7, 8. In the case of the first direction of rotation 15 of the drive wheel 5, the first intermediate wheel 6 reaches the first driving position 16, in which this meshes with the first output wheel 7 so that the drive wheel 5 rotationally drives the first output wheel 7 via the first intermediate wheel 6. In the first direction of rotation 15, the second intermediate wheel 19 becomes disengaged from the second output wheel 8, and the second output wheel 8 is not driven when the drive wheel 5 rotates in the first direction of rotation 15. FIG. 2A shows the first intermediate wheel 6 in the first driving position 16 and the second intermediate wheel 19 disengaged from the second output wheel 8.

The reverse applies in the opposite, second direction of rotation 17. The first intermediate wheel 6 becomes disengaged from the first output wheel 7, and the first output wheel 7 is not driven. The second intermediate wheel 19 reaches the second driving position 18, in which it meshes with the second output wheel 8, and the drive wheel 5 rotationally drives the second output wheel 8 via the second intermediate wheel 19. FIG. 3 shows the second driving position 18 of the second intermediate wheel 19 with dotted lines.

As in FIG. 3, the wheel distribution gear mechanism 4 of the drive unit 1 of the third exemplary embodiment of the invention shown in FIG. 4A comprises a drive wheel 5, a first intermediate wheel 6, and a first output wheel 7. As in FIG. 3, the first intermediate wheel 6 is movably guided by way of a circular arc-shaped first guide 13 that is concentric with respect to the axis of rotation 12 of the drive wheel 5, with the first intermediate wheel 6 always meshing with the drive wheel 5. Rotation of the drive wheel 5 in the first direction of rotation 15 moves the first intermediate wheel 6 into the first driving position 16, in which the first intermediate wheel 6 meshes with the first output wheel 7 so that the drive wheel 5 rotationally drives the first output wheel 7 by way of the first intermediate wheel 6. The first driving position 16 of the first intermediate wheel 6 is shown with dotted lines in FIG. 4A.

In the third exemplary embodiment of the invention, the wheel distribution gear mechanism 4 of the drive unit 1 comprises only one intermediate wheel 6, which in the exemplary embodiment is the first intermediate wheel 6, and no second intermediate wheel 19.

In contrast to the first and second exemplary embodiments, the second output wheel 8 in the third exemplary embodiment of the drive unit 1 according to the invention shown in FIG. 4A is disposed coaxially with the drive wheel 5, and in the second direction of rotation 17 of the drive wheel 5 is rotated along with the drive wheel 5 via a freewheel 21.

The freewheel 21 has a special design in the exemplary embodiment; however, a conventional freewheel may also be used. The freewheel 21 has a circular groove, which is concentric with respect to the axis of rotation 12 of the drive wheel 5, in an end face of the drive wheel 5 facing the second output wheel 8, from which branches 22 originate to the outside or, in the exemplary embodiment, to the inside. The branches 22 extend obliquely with respect to radials, wherein all branches 22 are oblique in the same direction and, in the exemplary embodiment, have the same angle with respect to the radials. The circular groove including the branches 22 is referred to as a freewheel path 23 here. The freewheel path 23 is shown in FIG. 4B, which illustrates the drive wheel 5. In FIG. 4A, the drive wheel 5 is covered by the coaxial second output wheel 8 and is therefore not visible.

The second output wheel 8 has an elongated hole 24, which extends in a direction opposite that of the branches 22 of the freewheel path 23, obliquely with respect to a radial. One end of the elongated hole 24 is congruent with the circular groove of the freewheel path 23, and another end of the elongated hole 24 is spaced at an identical radial distance apart from the axis of rotation 12 of the drive wheel 5 as ends of the branches 22.

A pin, serving as a follower 25, is disposed in the elongated hole 24 and is displaceably guided in a longitudinal direction of the elongated hole 24 and engages in the freewheel path 23. The slants of the branches 22 of the freewheel path 23 and the opposite slant of the elongated hole 24 are oriented such that, during a rotation of the drive wheel 5 in the second direction of rotation 17, the pin forming the follower 25 enters from the circular groove of the freewheel path 23 into the branch 22 closest to the pin so as to non-rotatably connect the second output wheel 8 to the drive wheel 5. As a result, the second output wheel 8 rotates along with the drive wheel 5 in the second direction of rotation 17. During rotation of the drive wheel 5 in the first direction of rotation 15, the branch 22 in which the follower 25 is located, by virtue of the slant thereof, and the elongated hole 24, by virtue of the opposite slant thereof, push the follower 25 out of the branch 22 into the circular groove of the freewheel path 23. The second output wheel 8 is thereby decoupled from the drive wheel 5 and is not driven in the second direction of rotation 17.

The freewheel 21 has the freewheel path 23 including the oblique branches 22, the oppositely oblique elongated hole 24, and the follower 25 that can be displaced in the elongated hole 24 and engages in the freewheel path 23. Conversely, it is also possible for the freewheel path 23 to be provided in or at the second output wheel 8, and for the elongated hole 24 to be provided in the drive wheel 5 (not shown).

### LIST OF REFERENCE NUMERALS

### Drive Unit

1 drive unit
2 electric motor
3 gear mechanism
4 wheel distribution gear mechanism
5 drive wheel
6 first intermediate wheel
7 first output wheel
8 second output wheel
9 motor shaft
10 intermediate wheel shaft
11 axis of rotation of intermediate wheel
12 axis of rotation of drive wheel
13 guide of intermediate wheel
14 guide path
15 first direction of rotation
16 first driving position
17 second direction of rotation
18 second driving position
19 second intermediate wheel
20 second guide
21 freewheel
22 branch
23 freewheel path
24 elongated hole
25 follower

1. A drive unit comprising a wheel distribution gear mechanism comprising a drive wheel, a first intermediate wheel, a first output wheel, which can be rotationally driven by the drive wheel via the first intermediate wheel, a first guide for the first intermediate wheel, which movably guides the first intermediate wheel on a circular path that is concentric with respect to an axis of rotation of the drive wheel so that, in a first driving position of the first intermediate wheel, the first output wheel an be rotationally driven by the drive wheel via the first intermediate wheel, wherein the first guide for the first intermediate wheel is self-locking free so that torque, which is transmitted by the drive wheel to the first intermediate wheel during rotational driving, moves the first intermediate wheel into the first driving position when driven in a first direction of rotation.

2. The drive unit according to claim 1, wherein the wheel distribution gear mechanism comprises a second output wheel, which can be rotationally driven by the drive wheel via the first intermediate wheel; and the torque transmitted by the drive wheel to the first intermediate wheel during rotational driving moves the first intermediate wheel into a second driving position, when driven in a second direction of rotation opposite the first direction of rotation, in which the second output wheel can be rotationally driven via the first intermediate wheel.

3. The drive unit according to claim 1, wherein the guide has a circular curve guide, which movably guides the first intermediate wheel on the circular path that is concentric with respect to the axis of rotation of the drive wheel.

4. The drive unit according to claim 3, wherein the first intermediate wheel comprises an intermediate wheel shaft, which rolls on a concave guide path of the circular curve guide that faces the drive wheel and extends concentrically about the axis of rotation of the drive wheel in a circular arc.

5. The drive unit according to claim 1, wherein the drive unit comprises the first intermediate wheel and a first guide for the first intermediate wheel, which movably guides the first intermediate wheel on a circular path that is concentric with respect to an axis of rotation of the drive wheel; the first guide is self-locking free so that torque, which is transmitted by the drive wheel to the first intermediate wheel during rotational driving, moves the first intermediate wheel into the first driving position when driven in a first direction of rotation so that the drive wheel rotationally drives the first output wheel via the first intermediate wheel, and the drive unit comprises a second intermediate wheel and a second guide for the second intermediate wheel, which movably guides the second intermediate wheel on a circular path that is concentric with respect to the axis of rotation of the drive wheel; and the second guide is self-locking free so that torque, which is transmitted by the drive wheel to the second intermediate wheel during rotational driving, moves the second intermediate wheel into a second driving position when driven in a second direction of rotation opposite the first direction of rotation so that the drive wheel rotationally drives the second output wheel via the second intermediate wheel.

6. The drive unit according to claim 1, wherein the wheel distribution gear mechanism comprises a second output wheel, which is coaxial with the drive wheel, and a freewheel, which, during rotational driving in a second direction of rotation opposite the first direction of rotation, non-rotatably connects the second output wheel to the drive wheel, and during rotational driving in the first direction of rotation, decouples the second output wheel from the drive wheel.

7. The drive unit according to claim 6, wherein the freewheel has a circular curve, which is concentric with respect to the axis of rotation of the drive wheel and of the second output wheel, comprising branches, which are oblique with respect to radials, and a follower, which can be moved back and forth between the circular curve and ends of the branches, obliquely with respect to a radial, in a direction opposite the slants of the branches.

8. A drive unit according to claim 1, wherein the wheel distribution gear mechanism comprises a gear wheel distribution gear mechanism.
